(19) United States
(12) Patent Application Publication
(10) Pub. No.: US 2013/0214114 A1
(43) Pub. Date: Aug. 22, 2013

(54) PORTABLE DEVICE STAND

(71) Applicant: George P. Gruber, (US)

(72) Inventor: George P. Gruber, Hudson, WI (US)

(73) Assignee: George P. Gruber, Hudson, WI (US)

(21) Appl. No.: 13/771,180

(22) Filed: Feb. 20, 2013

Related U.S. Application Data
(60) Provisional application No. 61/633,853, filed on Feb. 21, 2012.

(51) Int. Cl. F16M 11/22

(52) U.S. Cl. CPC F16M 11/22
USPC 248/463

(57) ABSTRACT

An apparatus is provided for supporting a handheld electronic device. The apparatus generally includes a support attached to a base via a first hinge and a brace attached to the support via a second hinge. The support is movable between support storage and use positions and the brace is moveable between brace support and use positions. When the support and brace are in the storage positions the brace is positioned within the dimensions of the support and the apparatus is generally planar.

### PRIORITY

This application claims priority to U.S. Provisional patent application Ser. No. 61/633,853 filed Feb. 21, 2012.

### FIELD OF THE INVENTION

The present invention relates a stand for receiving an electronic device such as a phone or a tablet.

### BACKGROUND OF THE INVENTION

The use of mobile phones and tablets has become widespread. Although these devices are typically held is the users hand(s), there are instances when it is not desirable for a user to hold the device. In these instances, the user may place the device on a surface, however, it is often difficult to view the screen of the device when it is positioned on a horizontal surface.

It is therefore desirable to provide an apparatus for positioning the device in a manner which provides for easy viewing of the device's screen but which also does not require the user to hold the device in his/her hand(s).

### SUMMARY OF THE INVENTION

An apparatus is provided which allows the user of phone or tablet to place the phone or tablet at a desired viewing angle while not requiring the use to hold the phone or tablet in his/her hand(s).

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a front perspective view of a the stand of the present invention positioned in a use position;

FIG. 2 is an exploded perspective view of the stand of the present invention positioned in a use position;

FIG. 3 is a rear perspective view of the stand of the present invention positioned in a use position;

FIG. 4 is a front perspective view of the stand of the present invention positioned in a storage position;

FIG. 5 is a bottom view of the stand of the present invention positioned in a storage position;

FIG. 6 is a side view of the stand of the present invention positioned in a storage position;

FIG. 7 is a front perspective view of the stand of the present invention positioned in a use position with a device mounted thereon;

FIG. 8a is an elevated view of a first embodiment of a base portion of the present invention; and

FIG. 8b is an elevated view of a second embodiment of a base portion of the present invention.

### DETAILED DESCRIPTION OF THE ILLUSTRATED EMBODIMENTS

While the invention may be susceptible to embodiment in different forms, there is shown in the drawings, and herein will be described in detail, a specific embodiment with the understanding that the present disclosure is to be considered an exemplification of the principles of the invention, and is not intended to limit the invention to that as illustrated and described herein.

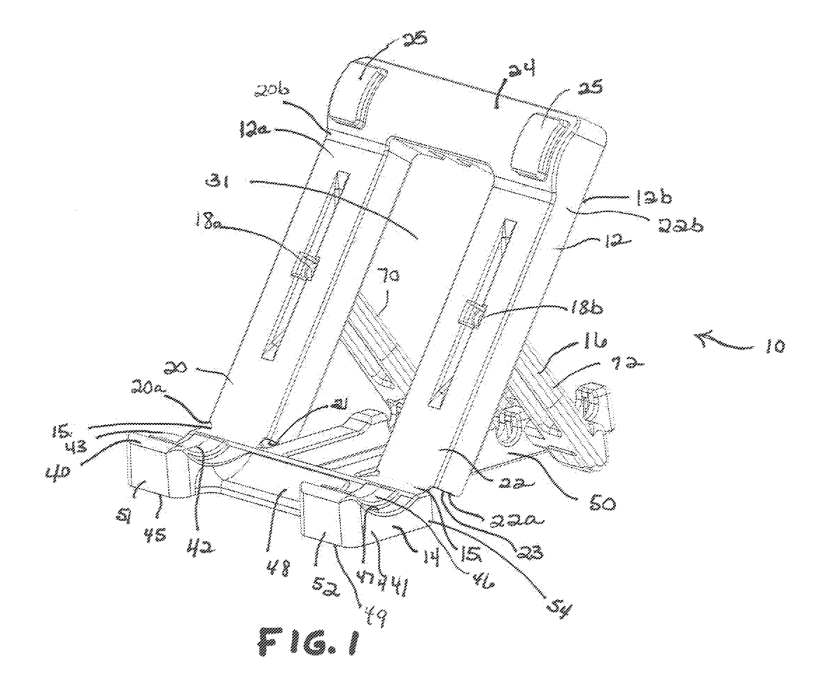

As illustrated in FIG. 1, the stand 10 generally includes a support 12, a base 14, a first hinge 15 for attaching the support 12 to the base 14, a brace 16, a second hinge 18 for attaching the brace 16 to the support 12, and a locking member 94.

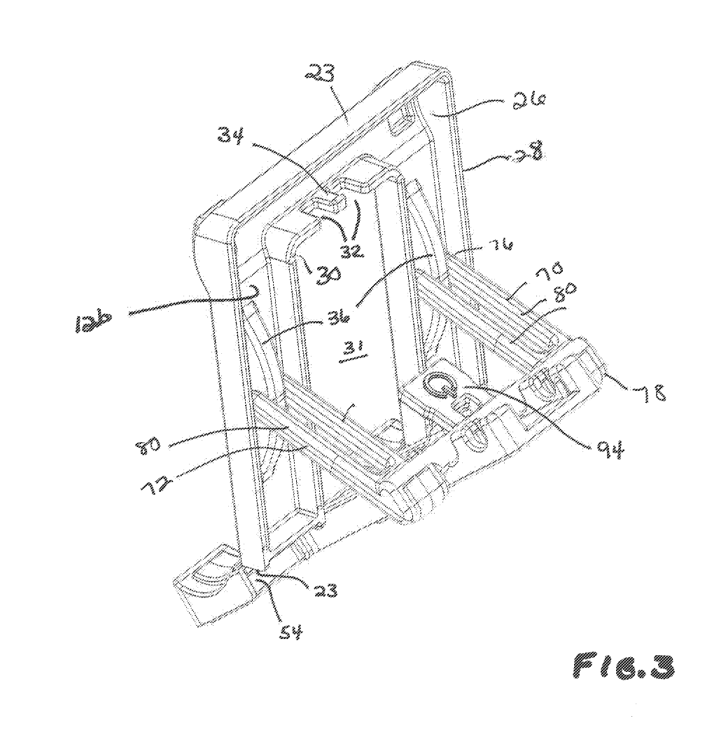

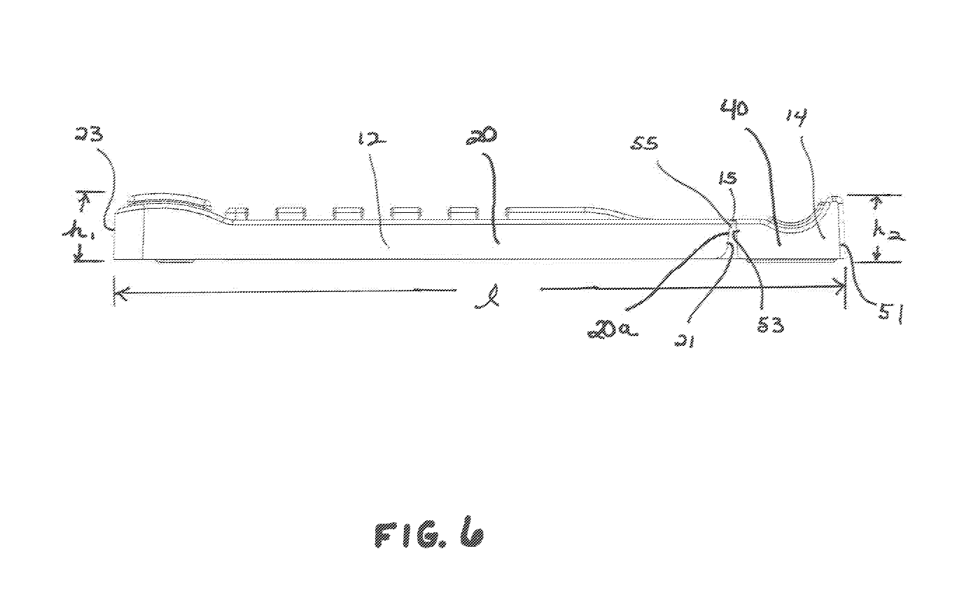

The support 12 generally includes a front side 12a and a rear side 12b. The support 12 is unitarily formed and generally includes a first arm 20, a second arm 22 and a cross member 24. The first arm 20 includes a lower end 20a and an upper end 20b. An end surface 21 (see FIG. 6) is provided at the lower end 20a of the first arm 20. The second arm 22 includes a lower end 22a and an upper end 22b. An end surface 23 is provided at the lower end 22a of the second arm 22. Front surfaces of the arms 20, 22 are generally planar. The cross member 24 extends from the upper end 20b of the first arm 20 to the upper end 22b of the second arm 22. An outer surface 23 (see FIGS. 3 and 6) of the cross member 24 provides an upper end of the stand 10. The front surface of the cross member 24 is generally arcuate-shaped and extends outwardly from the front surface of the arms 20, 22. The cross member 24 further includes support pads 25 extending outwardly from the front surface of the cross member 24.

The rear side 12b of the support 12 is best shown in FIG. 3. A cavity 26 is provided by the support 12. The cavity 26 defines a generally U-shaped outer edge 28 and a generally U-shaped inner edge 30. The inner edge 30 generally defines an aperture 31 positioned between the arms 20, 22 and extending from the cross member 24 to the base 14. Locking member reliefs 32 are provided along the inner edge 30 to define a support catch member 34. Each arm 20, 22 of the support 12 includes a hinge pin receptor 36 positioned with the cavity 26. The receptors 36 are generally arcuate-shaped. The depth of each receptor 36 is greatest at the center of each receptor 36 and a hinge pin passageway 37 is provided proximate the center of the receptor 36 for receiving the brace 16 as will be described herein.

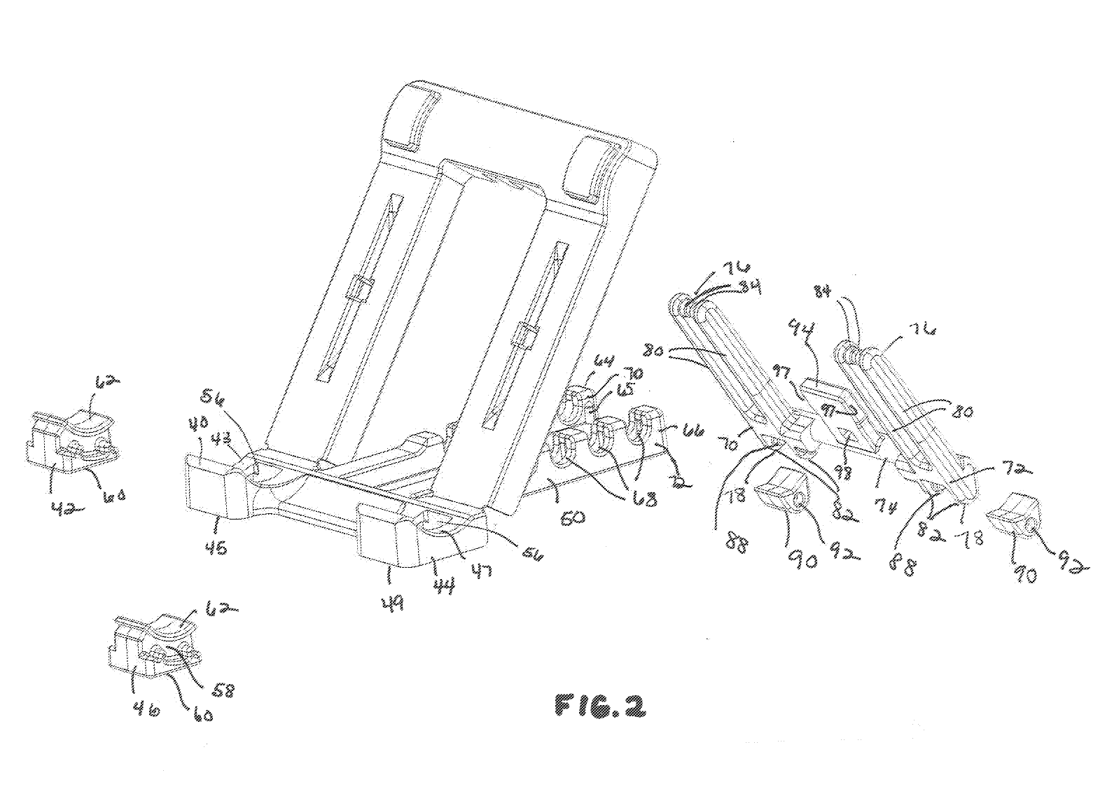

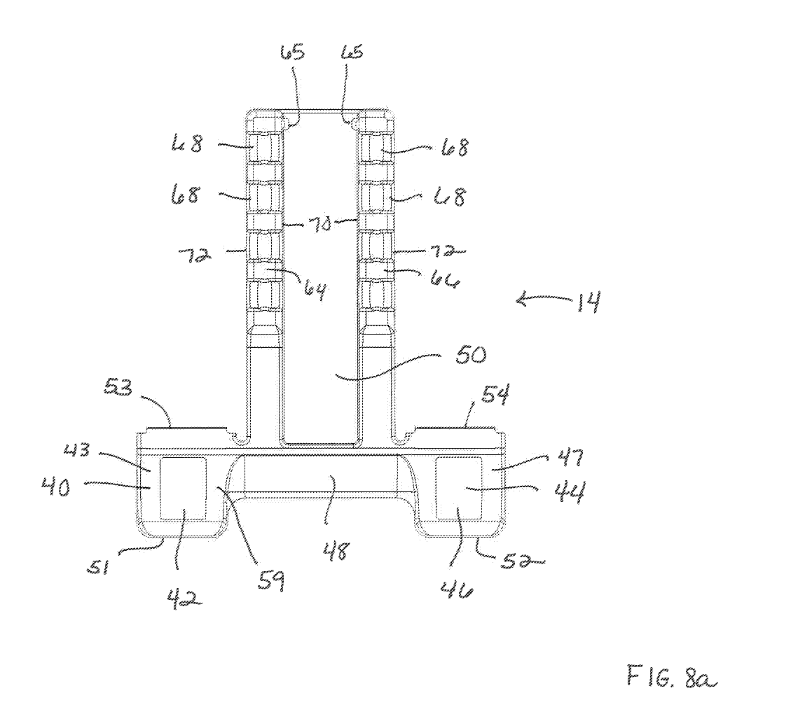

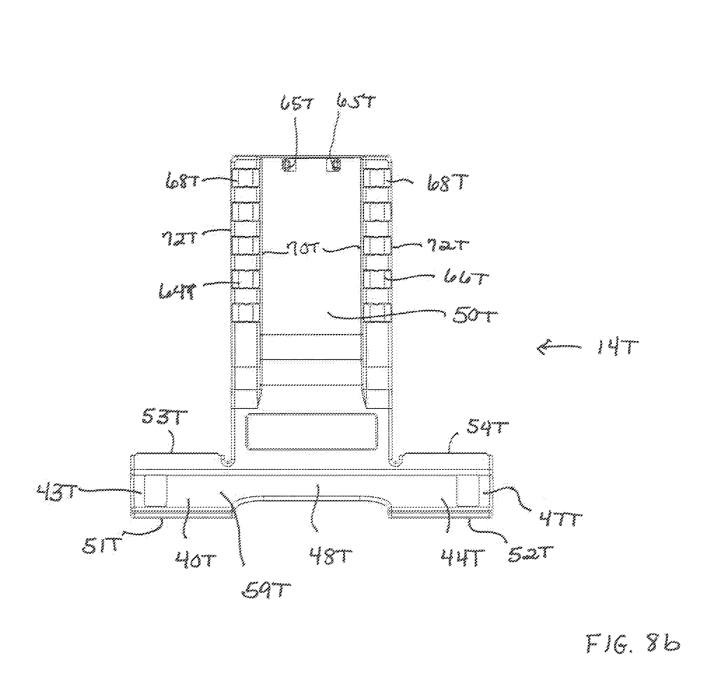

A first embodiment of the base 14 is illustrated in FIG. 8a. This first embodiment is proportioned for example to receive a cell phone. As illustrated in FIG. 8a, the base 14 is generally T-shaped and includes a first foot 40 along with a foot pad 42, a second foot 44 along with a foot pad 46, a rail 48, and a tongue 50. The rail 48 extends from the first foot 40 to the second foot 44 and the tongue 50 extends from and generally perpendicular to the rail 48. The first foot 40, second foot 44 and rail 48 generally define a platform 59 which receives the device as will be described herein. The first foot 40 generally includes a planar outer end surface 51, an inner end surface 53, an upper surface 43 and a lower surface 45 (see FIG. 1). The second foot 44 includes a planar outer end surface 52, an inner end surface 54 an upper surface 47 and a lower surface 49 (see FIG. 1). As best shown in FIG. 2, each foot 40, 44 defines a footpad passageway 56 for receiving the foot pads 42, 46. Each foot pad 42, 46 includes a central support member 58, a lower planar-shaped flange 60, and an upper arcuate-shaped flange 62. As best shown in FIG. 1, when inserted in the passageway 56, the upper arcuate-shaped flange 62 of the foot pad 42, extends over the portion of the platform 59 provided by the foot 40 and the upper arcuate-shaped flange 62 of the foot pad 46 extends over the portion of the platform 59 provided by the foot 44. The tongue 50 extends generally perpendicular to the rail 48 and end surfaces 51, 52 of the feet 40, 44. As best shown in FIGS. 2. and 8a, the tongue 50 defines an elongated first rail 64 and an elongated second rail 66. Each rail 64, 66 includes an inner surface 70 and an outer surface 72. An inwardly extending base locking member 65 extends from the inner surface 70 of each rail 64, 66. The base locking members 65 interact with the locking member 94 as will be described herein. Each rail 64, 66 further includes plurality of reception grooves 68. The reception grooves 68 of the first rail 64 are aligned with the reception grooves 68 of the second rail 66 and receive the brace 16 as will be described herein.

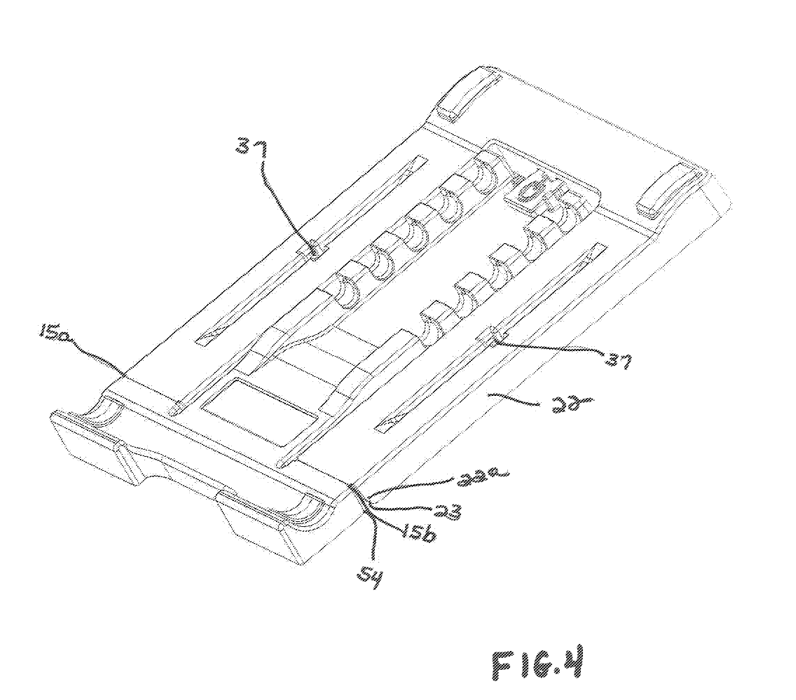

A second embodiment of the base 14T is illustrated in FIGS. 4, 5, and 8b. The base 14T is proportioned to receive a larger device such as for example, a tablet. When using the base 14T, the support 12 and brace 16 are proportioned to correspond with the base 14T. Thus, although the dimensions of the base 14T vary from the dimension of the base 14, except as noted herein, the elements of the base 14T and the interaction of the base 14T with the remaining elements of the stand is similar to the base 14 and a description of the similar features is not repeated. It is to be understood, therefore that if appropriately dimensioned, the base 14T can be substituted for the base 14. For clarification of the drawings, features of base 14T have been denoted with the letter “T”. Unlike the base 14 which includes locking members 65 extending inwardly from the rails 64, 66 of the tongue 50 of the base 14, the base 14T, includes locking members 65T which are spaced from the rails 64T, 66T. This spaced positioning of the locking members 65T allows the locking member 65T to interact with the locking member 94 despite the larger dimensions of the base 14T.

As best shown in FIG. 1, the first hinge 15 is provided by first hinge portion 15a of thin flexible material and second hinge portion 15b of thin flexible material. The first hinge 15 is a living hinge type. As best illustrated in FIGS. 4 and 6, the first portion 15a extends from the lower end 20a of the first arm 20 of the support 12 such that the end surface 21 of the arm 20 is spaced from the inner end surface 53 of the foot 40 of the base 14. The second portion 15b extends from the lower end 22a of the second arm 22 of the support 12 such that the end surface 23 of the arm 22 is spaced from the inner end surface 54 of the foot 44 of the base 14 The first hinge 15 provides for movement of the support 12 from a storage position to the use position as will be described herein.

The support 12, base 14 (with the exception of the foot pad 42, 46), and first hinge 15 are integrally formed using a molding process. The foot pads 42, 46 are formed from a resilient material which allows the pads to be easily deformed upon the application of pressure and which allows the pad to return its original shape upon the release of that pressure.

As best shown in FIG. 2, the brace 16 generally includes a first arm 70, a second arm 72 and a cross brace 74. Each arm 70, 72 also generally includes a hinged end 76 and a free end 78 opposite the hinged end 76. Each arm 70, 72 further incudes a set of hinge fingers 80 extending from the cross brace 74 and a set of free fingers 82 extending from the cross brace 74 opposite the hinge fingers 80. An inwardly extending hinge pin 84 is provided at the free end of each finger 80. Each hinge pin 84 interacts with the hinge pin passageway 17 of the hinge pin receptor 36 of the support 12. Each finger 82 includes an inwardly extending abutment pin 88. A resilient abutment member 90 is provided in connection with the free fingers 82 at the free end 78 of each arm 70, 72. Each abutment member 90 includes passageway 92 therethrough which receives the abutment pins 88 extending from the free fingers 82.

A locking member 94 extends generally perpendicular from the center of the cross brace 74. The locking member 94 is generally rectangularly-shaped and includes outer side edges 97 and a locking passageway 98 therethrough. The outer side edges 97 serve as a brace catch member as will be described herein.

The brace 16 (with the exception of the abutment pads 90) and locking member 94 are integrally formed using a molding process. The abutment pads 90 are formed from a resilient material which allows the pads to be easily deformed upon the application of pressure and which allows the pad to return to its original shape upon the release of that pressure.

Assembly and use of the stand will now be described.

The foot pad 42 is inserted into the foot pad passageway 56 of the base 14 by compressing the footpad 42 sufficiently to allow the upper flange 62 of the foot pad 42 to pass through the foot pad passageway 56 and extend over upper surface 43 of the foot 40. Upon release of the compression on the foot pad 42, the upper flange 62 will engage the portion of the platform 59 provided by the foot 40 to prevent the foot pad 42 from exiting the passageway 56 in a downward direction and the lower flange 60 will engage the lower surface 45 of the foot 40 to prevent the foot pad 42 from exiting the passageway 56 in an upward direction. In the same manner, the foot pad 46 is inserted into the passageway 56 of the foot 44.

An abutment member 90 is compressed to position the abutment member 90 between the free fingers 82 of the arm 70. The abutment member 90 is positioned to align the passageway 92 with the pins 88 of the arm 70. Upon alignment, compression of the abutment member 90 is released to secure the abutment member 90 to the arm 70 of the brace 16. A second abutment member 90 is mounted in the same manner to the arm 72 of the brace 16.

Connection between the support 12 and the brace 16 is provided by flexing the hinge fingers 80 of the arm 70 of the brace 16 outwardly until the hinge pins 84 of the arm 70 are sufficiently spaced to be positioned on either side of the hinge pin receptor 36 of the support 12. Upon alignment of the hinge pins 84 of the arm 70 with the hinge pin passageway 37 of the receptor 36, the hinge fingers 80 are released and the hinge pins 84 will extend in the hinge pin passageway 37 of the receptor 36. This process is repeated with the arm 72 of the brace 16 to connect the arm 72 of the brace 16 to the receptor 36 of the second arm 22 of the support 12. Connection of the brace 16 to the support 12 provides the second hinge 18 of the stand 10.

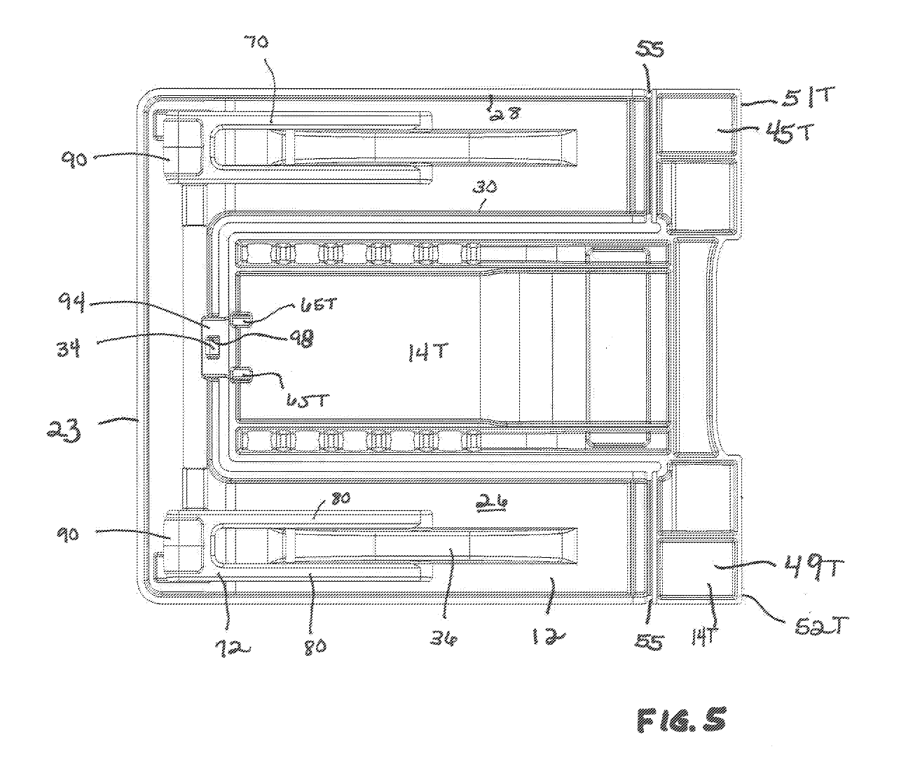

The first hinge 15 and the second hinge 18 allow the stand 10 to be moved between a use position as illustrated in FIGS. 1-3 and 7 and a storage position as illustrated in FIGS. 4-6. To move the stand 10 from the use position to the storage position, the user begins by moving the brace 16 from a brace use position to a brace storage position. From the brace use position (as shown in FIGS. 1-3 and 7, the brace 16 is rotated about the hinge 18 to position the arms 70, 72 of the brace 16 within the cavity 26 provided by the arms 20, 22 of the support 12 and the cross brace 74 of the brace 16 is positioned within the cavity 26 defined by the cross member 24 of the support 12. Furthermore, the catch member 34 of the support 12 extends within the locking member aperture 98 of the locking member 94 to secure the brace 16 in the brace storage position illustrated in FIGS. 4-6. As shown in FIG. 5, the relative dimensions of the support cavity 26 and the brace 16 allow the brace 16 to reside entirely within the support 12.

Movement of the stand 10 to the storage position continues by rotating the support 12 from the support use position illustrated in FIGS. 1-3 and 7 to a support storage position illustrated in FIGS. 4-6. The user rotates the support 12 relative to the base 14 about the living hinge 15. When the support 12 reaches the support storage position, the tongue 50 of the base 14 will be positioned within the aperture 31 defined by the arms 20, 22 and cross member 24 of the support 12. Furthermore, the base locking member 65 on the rails 64, 66 of the tongue 50 engage the side edges 97 of the locking member 94 to secure the base 14 to the brace 16.

With the stand 10 in the storage position, the stand 10 is generally planar as illustrated in FIGS. 4-6 and a gap 55 is provided between the support 12 and the base 14. Additionally, the brace 16 fits within the cavity 26 of the support 12 and the tongue 50 of the base 14 fits within the aperture 31 of the support 12. In the storage position, therefore the length (l) of the stand 10 is defined by the distance from the outer surface 23 of the cross member 34 of the support 12 to the end surface 51 of the foot 40 of the brace 14 and the height (h1) of the stand 10 is defined by a dimension of the cross member 34 and the height (h2) of the stand is defined by the dimension of the surfaces 51, 52 of the fee 40, 44.

To position the stand 10 in the use position from the storage position, the user may press the tongue 50 of the base 14 to release the base locking member 65 from the side edges 97 of the locking member 94. Rotation of the base 14 relative to the support member 12 about the first hinge 15 continues until the tongue 50 contacts the surface on which the stand 10 is positioned. As illustrated in FIGS. 1-3 and 7, in the use position, the tongue 50 is placed in a horizontal position and the end surfaces 51, 52 of the feet 40, 44 are positioned generally vertically. The user then presses on the locking member 94 to release the locking member 94 from the support catch member 34. The user continues to press on the locking member 94 to rotate the brace 16 about the hinge 18 until the brace 16 engages the rails 70, 72 of the base 14. The user then selects appropriate aligned reception grooves 68 of the tongue 50 within which to position the cross brace 74 of the brace 16. The selection of the reception grooves 68 will determine the angle at which the support 12 is positioned relative to the base 14. The stand 10 is then locked into the use position by snap fitting the cross brace 74 of the brace 16 to the tongue 50 of the base 14. With the stand in the use position, the foot pads 42, 46 of the feet 40, 44 and the abutment pads 90 of the brace 16 contact the surface on which the stand 10 rests.

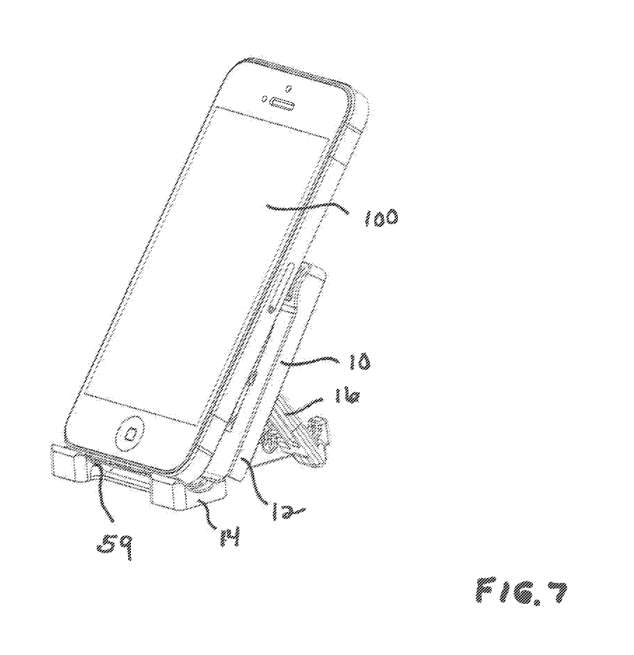

As illustrated in FIG. 7, in the use position, a user can then place a device 100 such as a cell phone or a tablet on the platform 59 of the base 14. The support 12 of the stand 10 positions the device in a manner which provides for comfortable viewing of content on the device. The device 100 can be orientated in a generally vertical position as shown or may be rotated to a horizontal position in accordance with the user's desires.

The stand 10 provides the advantage to the user of being able to maintain the device in a comfortable viewing position while not requiring the user to hold the device in his/her hands. In addition, if viewing of device is desired by multiple viewers, placement of the device on the stand 10 positioned between the viewers will make viewing more comfortable for all of the viewers. Moreover, when the stand 10 is placed in the storage position, the stand 10 is extremely compact and thus can be transported easily. The stand is formed utilizing cost efficient molding processes. Assembly of the stand 10 is simple due to the limited parts involved. Furthermore, no tools are required to assemble the stand 10.

While a preferred embodiment of the present invention is shown and described, it is envisioned that those skilled in the art may devise various modifications of the present invention without departing from the spirit and scope of the appended claims.

What is claimed is:

1. An apparatus for holding a device in a use position, the apparatus comprising:
a base;
a support attached to said base via a first hinge, said support moveable about said first hinge from a support storage position to a support use position;
a brace attached to said support via a second hinge, said brace moveable about said second hinge from a brace storage position to a brace use position; and
wherein when said brace is in said brace storage position, said brace does not extend beyond the dimensions of said support and when said brace is in said brace use position said brace is connected to said base.

2. The apparatus of claim 1, further including a brace locking member attached to said brace and said support includes a support catch member and wherein when said brace is in said brace storage position said brace locking member interacts with said support catch member to secure said brace in said storage position.

3. The apparatus of claim 1, wherein said base includes a base locking member and said brace locking member includes a brace catch member and wherein when said base is in said base storage position said base locking member interacts with said brace catch member to secure said base in said storage position.

4. The apparatus of claim 3, wherein said base further includes a tongue including a rail and said base locking member is provided on said rail.

5. The apparatus of claim 1, wherein when said support is placed in said support storage position and said brace is placed in said brace storage position the apparatus in generally planar-shaped.

6. The apparatus of claim 1, wherein when said brace is in said brace storage position, said brace is positioned within the outer dimension of the support member.

7. The apparatus of claim 1, wherein said support defines a cavity and wherein when said brace is placed in said brace storage position, said brace is positioned in said cavity.

8. The apparatus of claim 1, wherein said base further includes a foot pad.

9. The apparatus of claim 8, wherein said base further includes a foot pad passageway and said foot pad extends through said foot pad passageway.

10. The apparatus of claim 9, wherein an upper surface of said foot pad provides a platform for receiving said device and a lower surface of said foot pad contacts a surface supporting the apparatus.

11. The apparatus of claim 1, wherein said first hinge is a living hinge.

12. The apparatus of claim 11, wherein said base and said support are unitarily formed.

13. The apparatus of claim 1 wherein the support includes a hinge passageway and the brace includes hinge fingers, each finger having a hinge pin, wherein the hinge fingers are flexed outwardly to align the hinge pins with the hinge passageway and the hinge fingers are released to place the hinge pins within the hinge passageway.

14. The apparatus of claim 1, wherein said base includes a foot defining a foot passageway and a foot pad is positioned within said foot passageway.
